(19) United States
(12) Patent Application Publication
(10) Pub. No.: US 2005/0278225 A1
(43) Pub. Date: Dec. 15, 2005

(54) System and method for automated inventory management

(76) Inventor: Masao Tsuru Santa-Rosa, Mexico City (MX)

Correspondence Address: Burns & Levinson LLP, Suite 300, 1030 Fifteenth Street, N.W., Washington, DC, 20005-1501, US

(21) Appl. No.: 11/141,890

(22) Filed: Jun. 1, 2005

Related U.S. Application Data
(60) Provisional application No. 60/576,068, filed on Jun. 1, 2004.

(51) Int. Cl. G06F 17/60

(52) U.S. Cl. 705/22

(57) ABSTRACT

A method and system for inventory management control. Information pertaining to a point of sale is input by a user at a client and received by a server. A client identifier is assigned to the point of sale. Photographs and maps of the point of sale location may be viewed within the system to provide additional information for the management of inventory at a point of sale.

### CROSS REFERENCE TO RELATED APPLICATIONS

This application claims the priority under 35 U.S.C. § 119 of provisional application Ser. No. 60/537,713, entitled “Automated Inventory Upkeep System” filed Jun. 1, 2004.

### FIELD OF THE INVENTION

This invention relates to the field of inventory management, in general, and more particularly to a system and method for facilitating executive-level management of inventory and various point of sale locations.

### BACKGROUND OF THE INVENTION

Effective inventory management is critical for the successful operation of companies, franchises, stores, and other entities engaged in the practice of selling goods to customers at point of sale locations. Inventory management is known in the art.

The present invention allows the point of sale user to deepen his/her knowledge of various areas of the consumer market in order to optimize the budgets of promotion and publicity, and to provide an overview of the tools that allow the highly assertive decision making to remain on a management level. The knowledge must be obtained in various planes—geographic, statistical, and prospective with the dynamic aggregation of variables for the analysis of exchanged information.

Much of the prior art in the field of inventory planning is directed to determining stocking levels and timing to support predicted production levels, and is related to data processing, More recent art relates to planning, forecasting, and determining the inventories needed at various levels, with minimum financial investment.

U.S. Patent Application Publication No. 2002/0018513, by Hoffman et al., discloses a network from a supplier to point of sales, which includes distributors, warehouses, a communications network and a data center. Therein, the marketplace is analyzed, forecasts are made and comparisons with other suppliers are made. U.S. Patent Application Publication No. 2003/0050868, also by Hoffman et al. incorporates the previous application and adds product tracking. Published applications such as U.S. Patent Application Publication No. 2003/0074249 by Menninger et al and U.S. Patent Application Publication No. 2003/0069814 by Hoffman et al. attempt to apply inventory management applications to various industries, such as entertainment and health care management, respectively. The prior art systems described above fail to incorporate all of the elements disclosed in the present invention. In doing so, these systems fail to present the user with a cost-effective comprehensive application in which an enterprise can review and forecast the immediate and future inventory conditions of particular points of sale. The system of the present invention is addressed to solving these needs in the industry.

### SUMMARY OF THE INVENTION

The present invention relates to a system for determining the demands for, the stocking levels and usage of, and the planning for the inventory of an enterprise, said system comprising a datacenter of servers having internet capabilities, geographical information system, databases and survey services; a computer center connected to said datacenter; at least one point of sale outlet; and at least one portable input terminal capable of receiving data from and transmitting data to the at least one point of sale outlet and the datacenter.

An additional embodiment of the present invention relates to a system for determining the demands for, the stocking levels and usage of, and the planning for the inventory of an enterprise, said system comprising an inventory stock level determination service a geographical information system; a survey service; a market demographic analysis service; a customer preference analysis service; at least one database for storing information from said geographical information system, the survey service, the market demographic analysis service, customer preference analysis service, and the stock level determination service, survey services; a computer center connected to said datacenter; at least one point of sale outlet; and at least one portable input terminal capable of receiving data from and transmitting data to the at least one point of sale outlet and the datacenter.

It is an object of the present invention to provide a precise and user-friendly automated system for gathering detailed, relevant and timely information of the inventory volume and brands located at various points of sale.

It is another object of the invention to generate indicators that will allow the companies to react advantageously and preventatively to changes in the market, as opposed to proceeding without the indicators that the invention provides and thereby suffering from the effects of spastic variations within the market.

Another object of the invention is to reduce the high costs of opportunity of companies managing various points of sale. An additional object of the invention is to provide to the management companies a clear knowledge of the client sale location. Another object of the invention is to provide to the companies a clear knowledge of the consumer.

Another object of the invention is to establish mechanisms of operation and control to give precise pursuit to the marketing campaigns of the point of sale locations. Still another object of the invention is to generate knowledge about commercial practices, products of the competition and preferences of the consumer in the point of sale. An additional objective of the invention is to analyze geostatistical indicators that allow the executives to focus their efforts being based on patterns like income, socioeconomic levels and geographic criteria of consumption.

It is another object of the invention to know the physical state of the point of sale; the appearance of the displays, material items located at the point of sale, the volume or capacity of reflected in the displays, etc. Another object of the invention is to monitor the impact of the product brands in the point of sale.

### BRIEF DESCRIPTION OF THE DRAWINGS

FIG. 1 is an illustration of the customer interface of the inventory system of the present invention that is used to input the profile, management location and contact information of the point of sale.

FIG. 2 is an illustration of the customer interface of the inventory system of the present invention that is used to depict a map of a zip code in which individual points of sale are visibly located.

FIG. 3 is an illustration of the customer interface in which information pertaining to a layer name associated with a city section and zip code.

FIG. 4 is an illustration of the customer interface of FIG. 1 including a photographic illustration of the point of sale.

FIG. 5 is an example of the report view of the customer interface of the present invention in which survey, advertising and maintenance reports are generated.

FIG. 6 is an illustration of the customer interface of the inventory system that is used to depict a pictorial representation of the points of sale.

FIG. 7 is an illustration of the customer interface of the inventory system that is used to depict several pictorial representations of the points of sale.

FIG. 8 is an illustration of a customer interface of the inventory system that provides the user with additional details pertaining to the administration and photographic representation of a point of sale.

FIG. 9 is an illustration of the customer interface of the inventory system that depicts the location information pertaining to a specific point of sale.

FIG. 10 is an illustration of the customer interface of the inventory system that is used to depict maps containing zones in which individual points of sale are visibly located on streets within the zones.

FIG. 11 is an illustration of the customer interface inventory system that is used to depict maps showing relative locations of points of sale.

FIG. 12 is an illustration of the customer interface inventory system of that is used to depict more detailed maps showing points of sales on city streets.

FIG. 13 is a flow chart of the system flow of the inventory upkeep system as described herein.

### DESCRIPTION OF THE PREFERRED EMBODIMENT

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The physical structure of the network used to implement the present invention comprises a datacenter of server clusters with internet capability, geographical information system, business intelligence, databases, and polling/survey services. The operation of the present invention is designed to lead to new goals and ways of decision making within the infrastructures of the user's companies and stores. In addition to the server clusters, a computer center, portable input terminals and points of sales (PoS) outlets are included within the system..

The system of the present invention comprises a cluster of servers, a computer center, portable input terminals, and points of sales. Sales information can be determined by PoS terminals or by manual input to the portable terminals. The system is capable of determining stock levels at all points of sales, the geographic locations of all points of sales, the physical status and capacity of the points of sales, the market demographics of the areas served by the points of sales, the market preferences of the customers served by the points of sales, both by the goods sold by the enterprise and its competitors. The market demographics of the areas served by the points of sale can be performed by means of Internet surveys and sampling. Data is entered into the computer center and severs. Various programs and algorithms are used to determine inventory requirements, both immediate and future determination. The inventory requirements are adjusted based upon sales updates and predictions. Marketing plans and inventory stocking plans are also made based upon forecasts determined by the system.

The present invention may also be implemented through a handheld computer or personal digital assistant. Handheld computers can take several forms well known to those skilled in the art. Readily commercially available handheld computers have proven satisfactory for carrying out the method of the invention. Details concerning the construction, operation and programming of handheld computers used to carry out the present invention are available from the respective manufacturers.

In the preferred embodiment of the present invention, the handheld or personal digital assistant is equipped with the capability to capture and store digital images and pictures, capture, collect and store inputted data, and the capability to transmit data to a recipient server, either in real-time or after having stored and collected said data. In the preferred embodiment, the handheld computer or personal digital assistant is capable of transmitting data through a wireless network. Alternatively, the data may be transmitted through connected networks (e.g. through telephone lines).

A relational database is used to implement the system described herein. The concept of a relational database is well known in the art. For example, to implement the present invention, the user may “use” programs such as Oracle or MS-SQL. This list is inclusive and is not limiting to the examples set forth above. The system architecture includes at least seven servers. The servers include one web server, two database servers, two intelliegence server, and two geographical information service (GIS) servers.

The initial component of the present invention is focused on the establishment of goals and indicators, requirements of information operation, the definition of the models of initial surveys of those located within the geographic area of selected points of sale, and the definition of users and administrators for the future extraction of information. Additionally, the implementation of this component requires knowledge of the qualification of the company personnel that are going to use this tool in their operations.

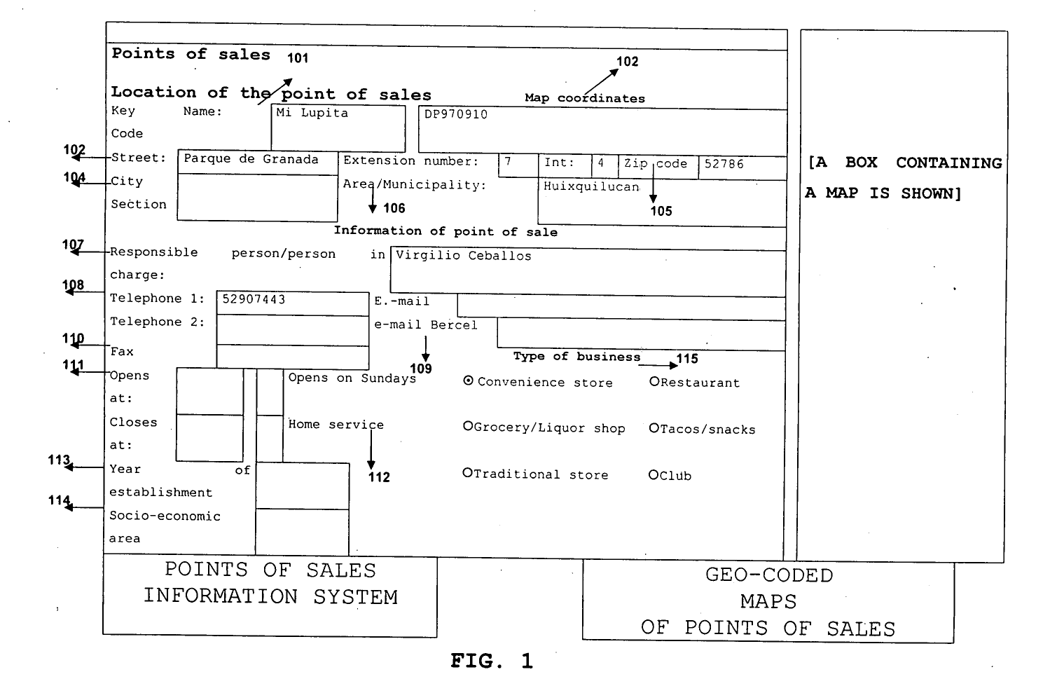

FIG. 1 provides an example of a customer interface of the preferred embodiment in which information pertaining to the point of sale are input by the user into the inventive system. The user is prompted by this interface to input information relative to the location of the point of sale such as the name 101 of the point of sale, the map coordinates 102 of the point of sale (discoverable by reference to a city or county map in which the point of sale is located), the street 103 on which the point of sale is located, the city section 104, zip code 105 and the area or municipality 106 in which the point of sale is located.

The user is also prompted to enter contact information relating to the point of sale such as the name 107, telephone number 108, electronic mail address 109, and facsimile number 110 of a contact person at the point of sale. Included in the customer interface is an area in which the user may input operational information relating to the point of sale such as the hours of operation 111, the availability of delivery service 112 to a customer's residence, the year 113 the point of sale location was established, and the socio-economic area 114 in which the point of sale is located.

Additionally, the user may be prompted to input the type of business 115 for the point of sale, including but not limited to a convenience store, a restaurant, a grocery or liquor shop, a taco or snack shop, a traditional store, or a club.

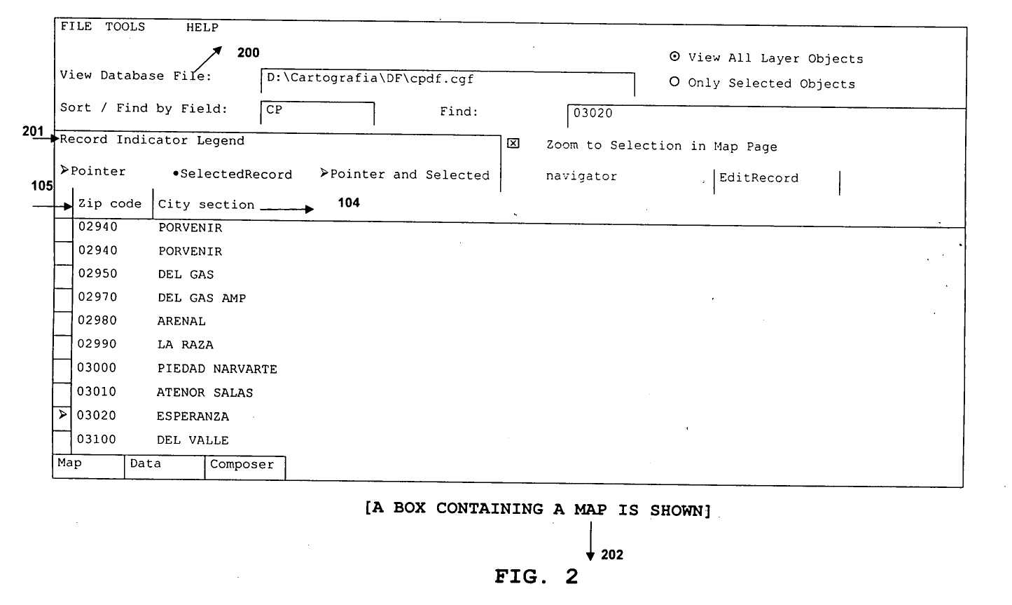

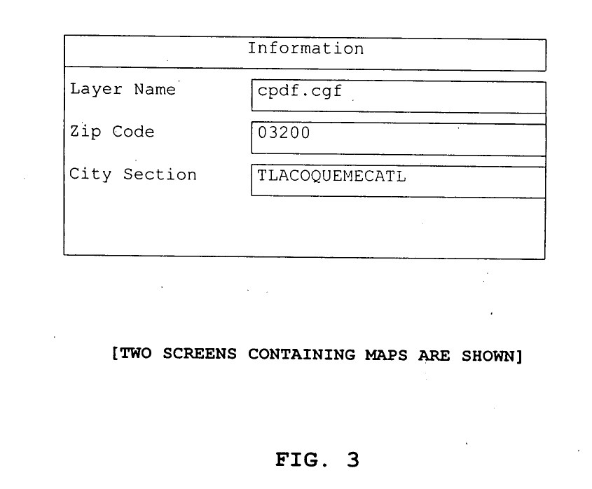

FIG. 2 provides an example of a customer interface in accordance with the preferred embodiment of the invention in which a relational database file 200 is correlated with a record indicator legend 201 specifying the zip code 105 and city section 104 in which a specified point of sale is located. The user has the viewing option of seeing only selected objects or all layer objects displayed on a map 202. FIG. 3 provides a customer interface in which detailed information pertaining to the layer name 300, zip code 105, and city section 104 of the displayed map is inserted the user.

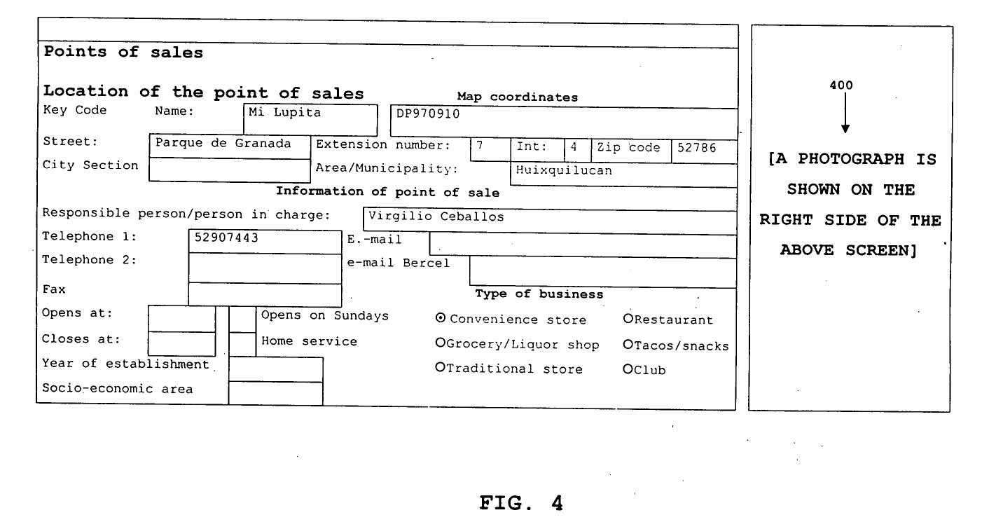

FIG. 4 depicts an alternative embodiment of the customer interface of FIG. 1 with a photograph 400 of the point of sale included therein.

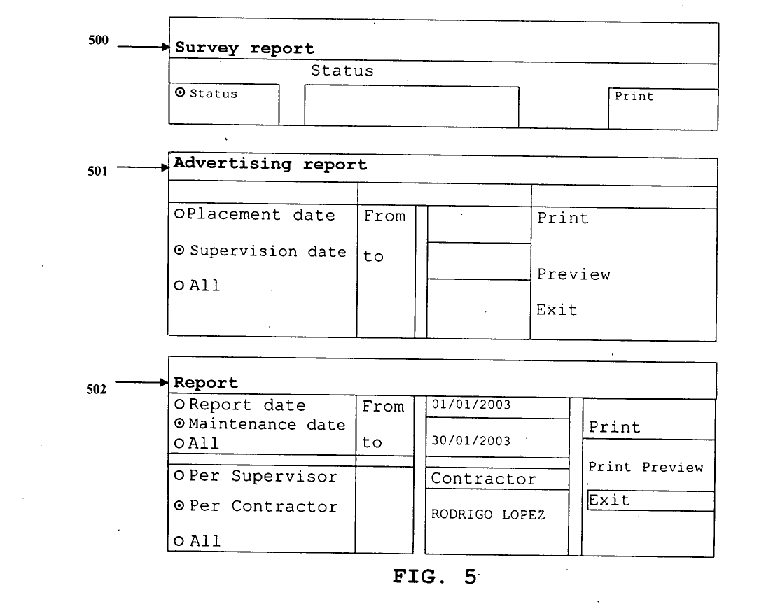

FIG. 5 depicts a customer interface in accordance with the inventive system in which survey reports 500, advertising reports 501, and a maintenance report 502 is generated for a specific point of sale location.

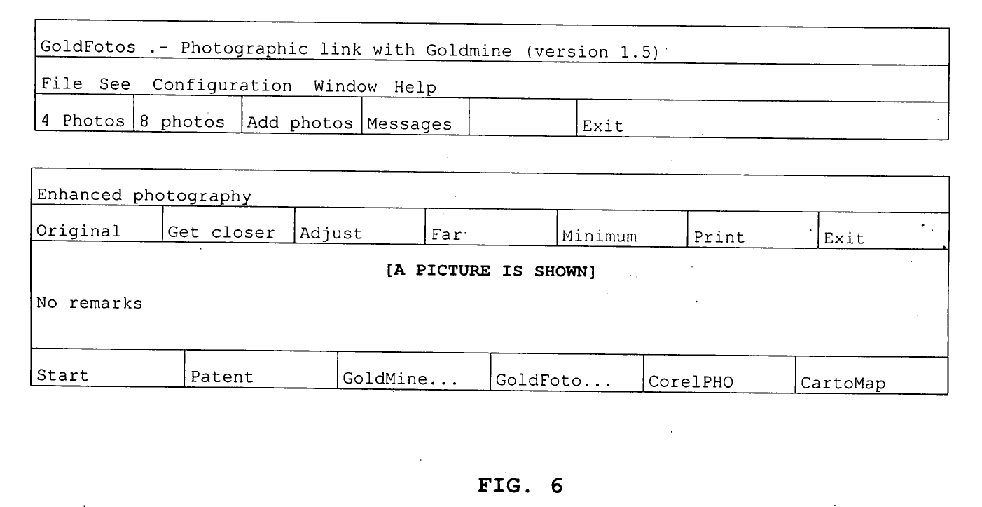

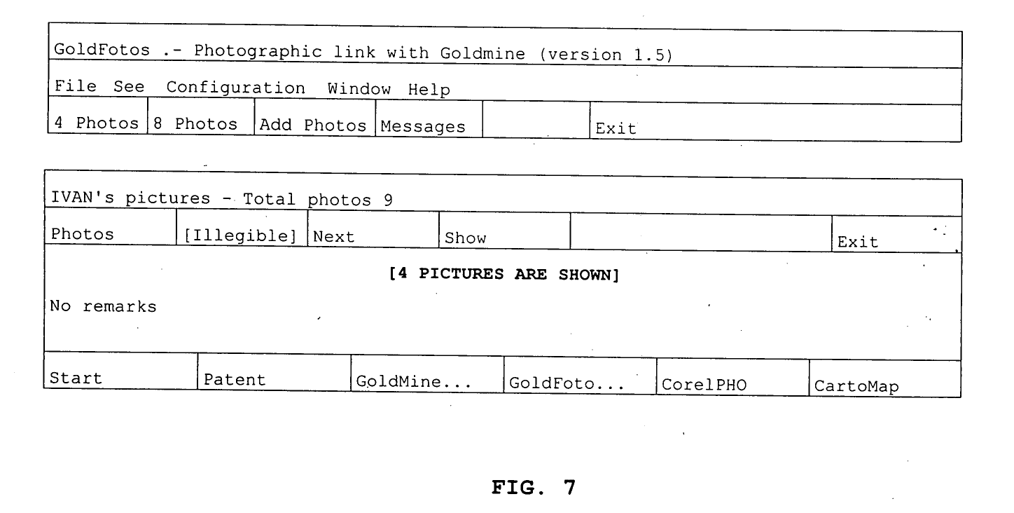

To provide further customization of the inventive system to a specific point of sale, the user may upload one or more photographs of a specific point of sale that may be viewed within the system by authorized administrators or representatives. FIG. 6 provides an example of a customer interface that depicts a picture of the point of sale. The photograph or picture may be viewed through the use of software such as GoldMine 6.5. FIG. 7 presents a view in which the customer may view four pictures of a particular point of sale.

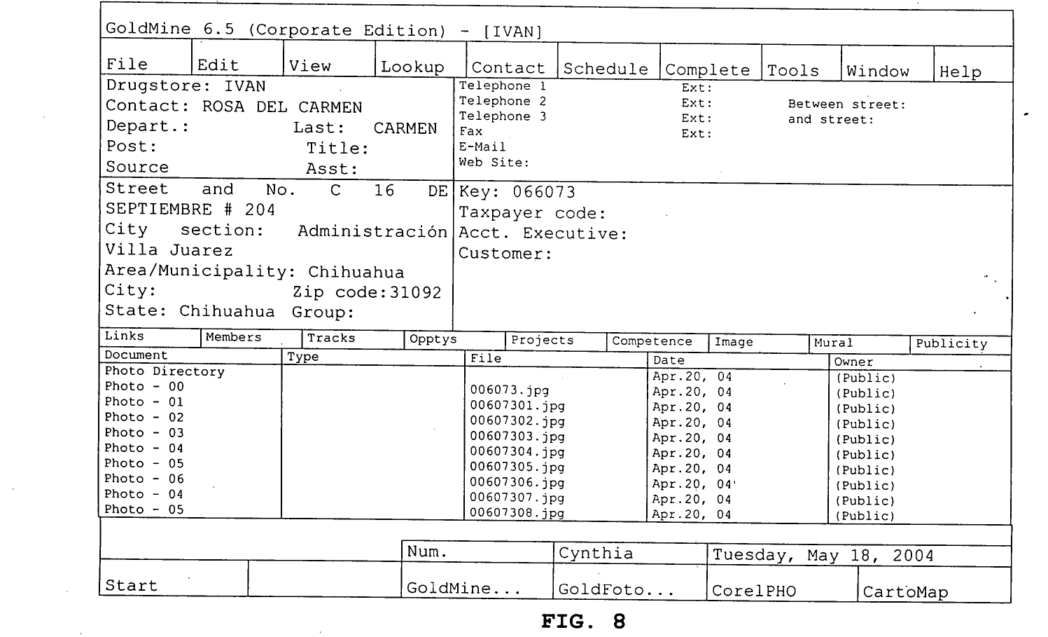

FIG. 8 provides an interface presented to a user for uploading and storing of files pertaining to various photographs of the point of sale locations. Much of the contact information displayed in FIG. 1 may be incorporated within this interface to provide the user with a single reference screen on which they can view the contact information and uploaded photographs in one instance.

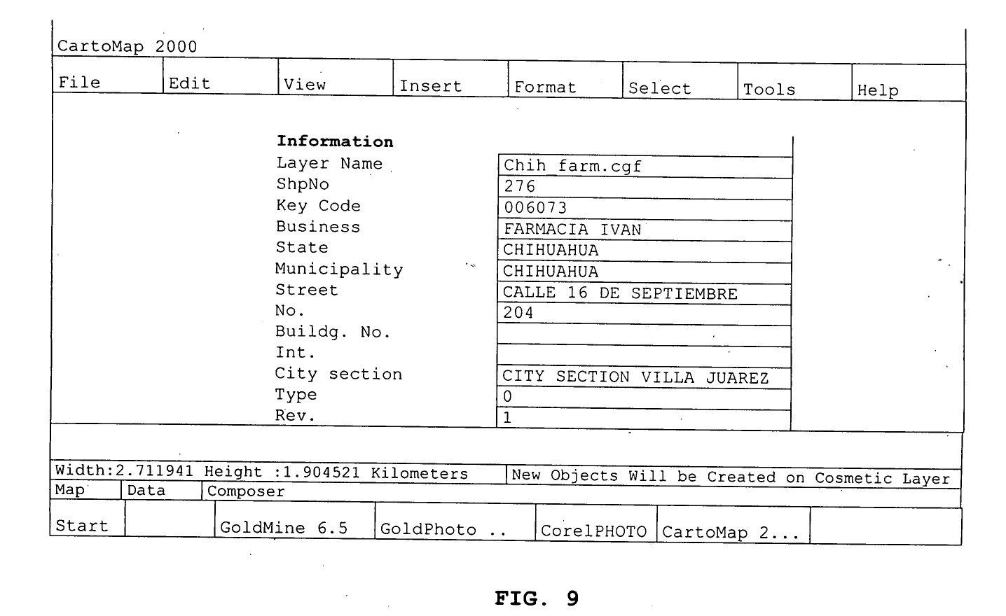

FIG. 9 provides an additional customer interface which may be presented to a user for storing, editing and formatting information pertaining to the location and type of business of the point of sale.

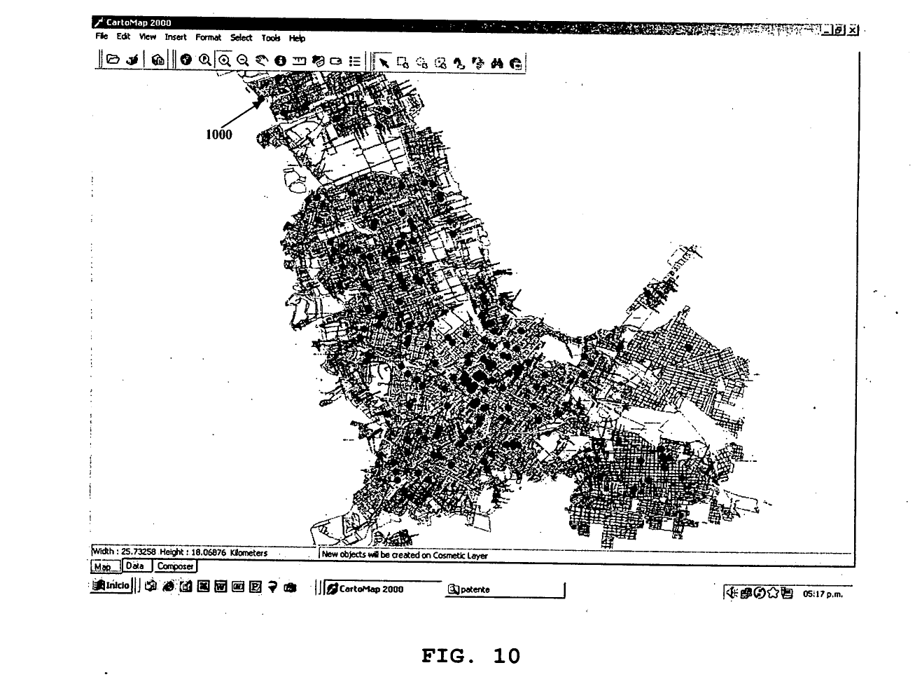

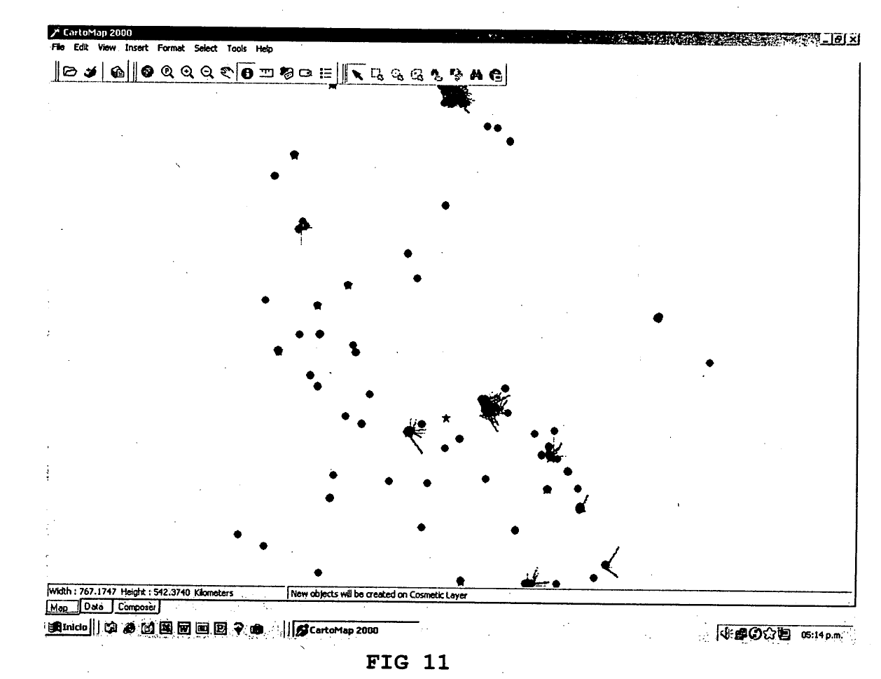

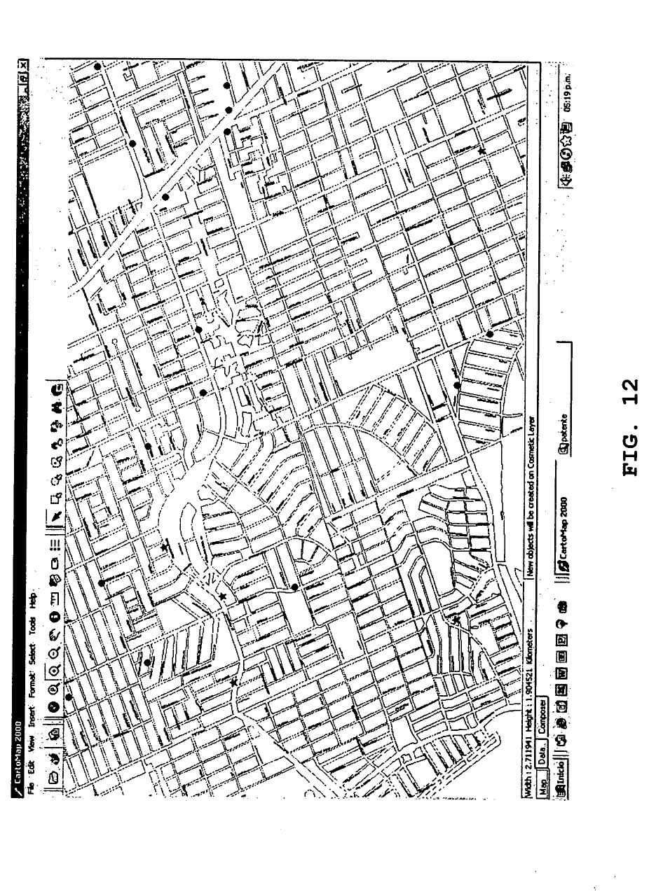

A company which owns many points of sale within a city may be able to view the layout of various points of sale in a zone, as depicted in FIG. 10. Points of sale 1000 are located on a grid which indicates the position of each point of sale on a city street. FIG. 11 provides a closer view of selected point of sale locations. FIG. 12 provides a view closer than that of FIG. 10 but farther away from that seen in FIG. 11. In this view, a user obtains the view of a neighborhood in which the names of various streets within a zone can be seen.

The development component of the preferred embodiment comprises several significant steps, including but not limited to that which is described herein. The implementation of the invention calls for the construction of the application based on the Initial Phase. There is also a component that generates the dynamic distribution of opinion polls to persons browsing the Internet according to the geographic location of those polled.

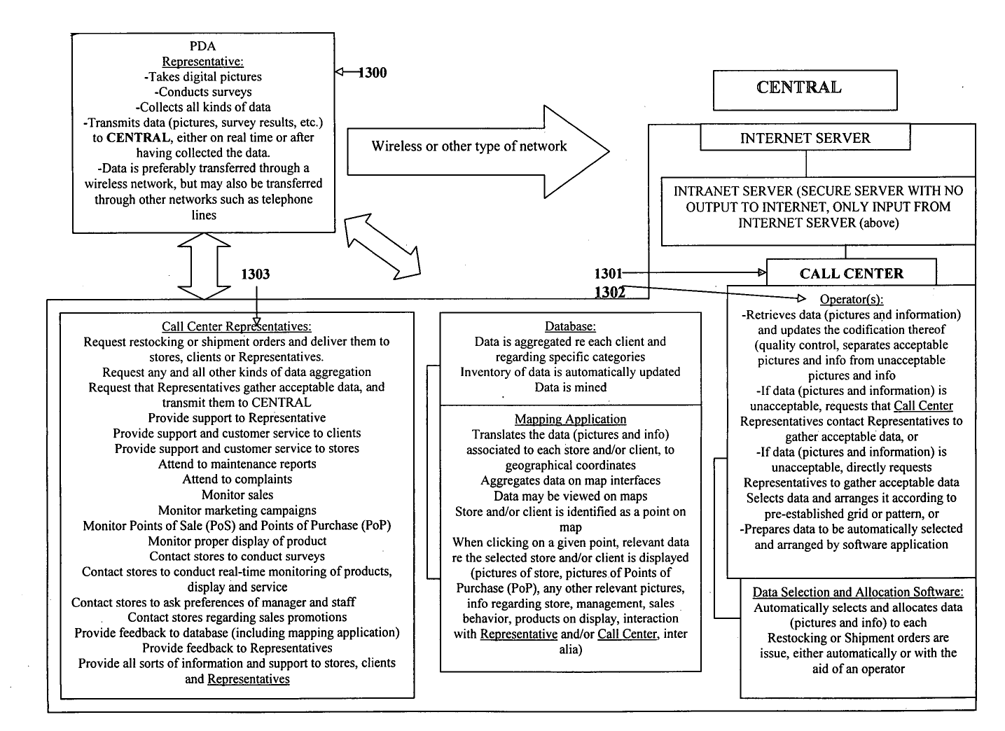

The next steps comprise the data collection and photography of the points of sale, synchronizations of data with the Internet browsing application, and harvesting and confirmation of data, securing of quality, etc. to travel of the Call Center. This is visually displayed in FIG. 13, and described in detail below.

The store representative/user transmits the data from a handheld computer or personal digital assistant 1300 to the Call Center 1301 preferably though a wireless network, however, said data may be transferred through telephone lines and other means of communication. Once the data is transmitted to the Call Center 1301, an operator 1302 retrieves pictures and other transmitted data information, and updates the system. Usable pictures and information are separated from whose which are not beneficial for the implementation of the system. If the data and pictures are unacceptable, the operator 1302 may request a call center representative 1303 to contact the store representative (information recorded in the interface seen in FIG. 1) to obtain replacements, or the operator 1302 may contact the store representative directly. Once the data and pictures have successfully passed through pre-screening, the operator 1302 selects the data and arranges is according to a pre-established grid or pattern. Alternatively, the operator 1302 may prepare the data to be automatically selected and arrange by the software application.

The data selection and allocation software automatically selects and allocates the pictures and data to each store and or client. Once this takes place, restocking or shipment orders are issued. The orders may be issued automatically or with the aid of an operator 1302 and/or call center representative 1303.

The development phase is commenced when a representative sample of points of sale locations is recorded in the data storage means of the invention.

The mapping application translates the data associates to each store and/or client to geographical coordinates. The application aggregates the data on map interfaces such that the data may be viewed on the map. The store and/or client is identified as a point on the map. As a result, when clicking on a given point on the map, relevant data regarding the selected store and/or client is displayed. The relevant data may include pictures of the store, pictures of points of sale (PoS), pictures of Points of Purchase (PoP), any other relevant pictures, information about the store, management information, sales trends, products on display, and a history of the interaction between the store representative and the call center.)

The analysis phase of the preferred embodiment is comprised of three components—information review, creating a permanent set of reports, and defining future goals for client achievement. The information recorded in the development phase is initially reviewed to produce various types of reports to aid the user in decision-making and management. In the preferred embodiment of the present invention, the reports are in the forms of maps, statistics and projections relating to specific points of sale.

In the analysis phase, the system further aids in setting goals and objectives for the user. By quantifying the volume of goods at various points of sale, and completing a qualitative analysis of the brands located therein, users of the embodied invention may be able to usher their companies, franchises and stores into increased levels of productivity and success.

It will be readily apparent to those skilled in the art that various changes and modifications of an obvious nature may be made, and all such changes and modifications are considered to fall within the scope of the appended claims. Other embodiments of the invention will be apparent to those skilled in the art from consideration of the specification and practice of the invention disclosed herein. In particular, it is noteworthy that the plates in the three embodiments may be any geometric shape. It is intended that the specification and examples be considered as exemplary only, with a true scope and spirit of the invention being indicated by the following claims and their equivalents.

1. A system-for determining the demands for, the stocking levels and usage of, and the planning for the inventory of an enterprise, said system comprising:
(a) a datacenter of servers having internet capabilities, geographical information system, databases and survey services;
(b) a computer center connected to said datacenter;
(c) at least one point of sale outlet; and
(d) at least one portable input terminal capable of receiving data from and transmitting data to the at least one point of sale outlet and the datacenter.

2. The system of claim 1, wherein the data center is capable of generating inventory management and upkeep reports.

3. The system of claim 1, wherein the data center provides feedback to the at least one portable input terminal, the computer center or an external client.

4. The system of claim 1, wherein data may be uploaded to or manually inputted into the at least one portable input terminal.

5. The system of claim 1, wherein the at least one portable input terminal may be a handheld computer or a personal digital assistant.

6. The system of claim 1, wherein the datacenter of servers additional has an inventory stock level determination service, a market demographic analysis service, and a customer preference analysis service.

7. The system of claim 1, wherein the at least one portable input terminal captures and stores digital images and pictures.

8. The system of claim 1, wherein the at least one portable input terminal captures and stores data.

9. A system for determining the demands for, the stocking levels and usage of, and the planning for the inventory of an enterprise, said system comprising:
(a) an inventory stock level determination service;
(b) a geographical information system;
(c) a survey service;
(d) a market demographic analysis service;
(e) a customer preference analysis service;
(f) at least one database for storing information from said geographical information system, the survey service, the market demographic analysis service, customer preference analysis service, and the stock level determination service, survey services;
(g) a computer center connected to said datacenter;
(h) at least one point of sale outlet; and
(i) at least one portable input terminal capable of receiving data from and transmitting data to the at least one point of sale outlet and the datacenter.

10. The system of claim 9, wherein data may be uploaded to or manually inputted into the at least one portable input terminal.

11. The system of claim 9, wherein the at least one portable input terminal may be a handheld computer or a personal digital assistant.

12. The system of claim 9, wherein the data center is capable of generating inventory management and upkeep reports.

13. The system of claim 9, wherein the data center provides feedback to the at least one portable input terminal, the computer center or an external client.

14. The system of claim 9, wherein the at least one portable input terminal captures and stores digital images and pictures.

15. The system of claim 9, wherein the at least one portable input terminal captures and stores data.
